(19) United States
(12) Patent Application Publication
(10) Pub. No.: US 2026/0091813 A1
(43) Pub. Date: Apr. 2, 2026

(54) SYSTEMS AND METHODS FOR INTELLIGENT DETECTION OF ABNORMAL CONDITIONS ASSOCIATED WITH SHIPPING CONTAINERS

(71) Applicant: BNSF Railway Company, Fort Worth, TX (US)

(72) Inventors: Evan M. Tarian, Fort Worth, TX (US); Michael S. Saniei, Fort Worth, TX (US); Israel A. Salazar, Beaumont, CA (US); Jeffrey R Longman, Springtown, TX (US)

(73) Assignee: BNSF Railway Company, Fort Worth, TX (US)

(21) Appl. No.: 19/340,128

(22) Filed: Sep. 25, 2025

Related U.S. Application Data
(60) Provisional application No. 63/700,464, filed on Sep. 27, 2024.

(51) Int. Cl. B61L 27/57; B61L 27/70; G06Q 10/083

(52) U.S. Cl. CPC B61L 27/57; B61L 27/70; G06Q 10/083

(57) ABSTRACT

Systems and techniques for intelligent detection of abnormal conditions associated with a shipping container. A system includes an on-site system configured to capture sensor data associated with a condition of a container carried by a train car of a train, analyze the sensor data to determine whether the condition of the container indicates an abnormal condition, and identify one or more of the train car, the container, and the train. The system also includes a backend system configured to receive a detection message from the on-site system and generate an alert signal in response to a determination that the condition of the container indicates an abnormal condition. The alert includes the abnormal condition and identification information, and causes one or more remedial actions to respond to the abnormal condition of the container.

### CROSS-REFERENCE TO RELATED APPLICATIONS

The present non-provisional application claims priority to U.S. Provisional App. No. 63/700,464, filed September 27, 2024, the disclosure of which is hereby incorporated by reference in its entirety for all purposes.

### TECHNICAL FIELD

The present disclosure relates generally to systems, and more particularly to systems and methods for intelligent detection of abnormal conditions associated with a shipping container.

### BACKGROUND

Rail transportation has long been a vital component of transportation infrastructure, enabling the efficient movement of goods over long distances. The use of standardized shipping containers, such as intermodal shipping containers, has further streamlined this process, allowing for seamless transfers between different modes of transportation. These intermodal containers can be easily loaded onto train cars, ships, and trucks, facilitating the global movement of goods.

While the containerized shipping system has greatly improved logistics efficiency, it has also presented new challenges in terms of security and theft prevention. The high value of goods transported in containers makes them attractive targets for theft. Train operators face increasing difficulties in maintaining the security of containers during transit, particularly over long journeys where constant surveillance is impractical.

Traditionally, security measures for shipping containers have relied heavily on physical seals and locks, as well as manual inspections at various points along the journey. However, these methods have limitations. Physical seals can be tampered with or replicated, and manual inspections are time-consuming and prone to human error. Additionally, the sheer volume of containers transported on a single train makes thorough individual inspections challenging.

Too many times, and unfortunately, the detection of theft or tampering often occurs only after the container has reached its final destination, at which point it may be too late to take effective remedial action. In many cases, it is the customer or recipient of the goods who first discovers signs of tampering or theft when the container reaches its final destination. This situation may occur days or even weeks after the actual security breach took place. Upon discovering the issue, the client may then report the incident to the railroad operator. This delayed detection and reporting process may be problematic for several reasons. It may limit the operator’s ability to conduct timely investigations, recover stolen goods, identify the point at which the security breach occurred, etc. Furthermore, allowing clients to be the first line of detection may damage the reputation of the railroad operator and erode trust in their ability to securely transport goods. This reactive approach to security may also make it challenging for operators to implement effective preventive measures or respond promptly to emerging theft patterns.

Advancements in technology, including sensors, imaging systems, and data analytics, have opened up new possibilities for enhancing container security. However, integrating these technologies into existing railway operations presents its own set of challenges, including issues of reliability, scalability, and the need to minimize disruptions to established workflows. Nonetheless, as the global demand for goods continues to grow, so does the importance of securing the supply chain. Improving the security of containerized railroad transport is not just a matter of preventing theft, but also of ensuring the integrity of the entire logistics system.

### BRIEF SUMMARY

The present disclosure achieves technical advantages as systems, methods, and computer-readable storage media that provide functionality for intelligent detection of abnormal conditions associated with a shipping container. In particular embodiments, a system may operate to capture sensor data associated with the container. The sensor data may include data associated with a condition of the container. The system may apply one or more models to the sensor data to detect the container within the sensor data, to classify the container, to filter out sensor data, to detect abnormal conditions of the container within the sensor data, and to generate one or more alerts in response to the detection of the abnormal conditions. In some embodiments, the system may utilize machine learning and artificial intelligence models to analyze the sensor data and identify potential security threats or operational issues related to the containers.

In embodiments, the system of embodiments may be configured to process data from multiple sensors, including cameras, radars, and other specialized equipment, to provide a comprehensive assessment of the container’s condition. In some embodiments, the system of embodiments may be configured to operate in real-time or near-real-time, enabling rapid detection and response to abnormal conditions. The alerts generated by the system of embodiments may be customized based on the severity and nature of the detected abnormal conditions, and may be directed to appropriate personnel or automated systems for immediate action. Additionally, the system of embodiments may maintain historical data on container conditions, enabling trend analysis and continuous improvement of detection algorithms over time.

The advantageous result of the present disclosure includes several technical improvements over conventional systems. For example, the disclosed system’s functionality to capture and analyze sensor data in real-time or near-real-time may significantly reduce the time between a security breach occurring and its detection. This rapid detection functionality may enable operators to respond more quickly to potential threats, potentially preventing theft or minimizing its impact. The system’s use of multiple sensors and advanced machine learning algorithms and models may improve the accuracy of abnormal condition detection, reducing false positives and negatives that can plague traditional security measure.

Another technical improvement provided by the system of embodiments includes the system’s automated approach to container inspection, which may greatly increase the scalability of security operations. While manual inspections may be limited by available personnel and time constraints, the automated system may be capable of continuously monitoring a large number of containers concurrently. This scalability may allow for more comprehensive security coverage without significantly increasing operational costs or causing delays in transportation schedules. Additionally, the system’s ability to maintain historical data and perform trend analysis may enable predictive maintenance and security strategies, which may prevent issues before they occur and may improve the overall reliability of container transportation.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for detecting abnormal conditions of shipping containers. In doing so, the present disclosure goes well beyond a mere application the manual process to a computer. Accordingly, the claims herein necessarily provide a technological solution that overcomes a technological problem.

In various embodiments, the system comprises one or more processors interconnected with a memory module, capable of executing machine-readable instructions. These instructions include, but are not limited to, the steps outlined in any flow diagram, system diagram, block diagram, and/or process diagram disclosed herein, as well as steps corresponding to any functionality detailed herein. In embodiments, the execution of these machine-readable instructions may involve initiating multiple concurrent computer processes. Each process of the concurrent computer process may be configured to handle or process a designated subset or portion of the of the machine-readable instructions. This division of tasks enables parallel processing, multi-processing, and/or multi-threading, enabling multiple operations to be conducted or executed concurrently rather than sequentially. This functionality for spawning a plurality of concurrent processes to manage separate portions of the machine-readable instructions markedly increases the overall speed of execution of the machine-readable instructions. By leveraging parallel or concurrent processing, the time required to complete a set or subset of program steps is substantially reduced (e.g., when compared to execution without concurrent or parallel processing). This efficiency gain not only accelerates the processing speed but also optimizes the use of processor resources, leading to an improved performance of the computing system. This enhancement in computational efficiency constitutes a significant technological improvement, as it enhances the functional capabilities of the processors and the system as a whole, representing a practical and tangible technological advancement. The result of this concurrent processing functionality results in an improvement in the functioning of the one or more processor and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model’s learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet‐centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet‐centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method for intelligent detection of abnormal conditions associated with a shipping container. It is a further object of the disclosure to provide a system for intelligent detection of abnormal conditions associated with a shipping container, and a computer-based tool for intelligent detection of abnormal conditions associated with a shipping container. These and other objects are provided by the present disclosure, including at least the following embodiments.

In one particular embodiment, a method for intelligent detection of abnormal conditions associated with a shipping container is provided. The method includes detecting a presence of a container carried by a train car of a train within an inspection area, capturing sensor data associated with a condition of the container, analyzing the sensor data to determine whether the condition of the container indicates an abnormal condition for the container, identifying one or more of the train car, the container, a train to which the train car belongs, and a train symbol associated with the train, and generating an alert signal in response to a determination that the condition of the container indicates an abnormal condition. In embodiments, the alert signal includes one or more of the abnormal condition, an identification of the train car, an identification of the container, an identification of the train to which the train car belongs, and the train symbol associated with the train. In embodiments, the alert signal causes one or more remedial actions configured to respond to the abnormal condition of the container.

In another embodiment, a system for intelligent detection of abnormal conditions associated with a shipping container is provided. The system comprises at least one processor and a memory operably coupled to the at least one processor and storing processor-readable code that, when executed by the at least one processor, is configured to perform operations. The operations include detecting a presence of a container carried by a train car of a train within an inspection area, capturing sensor data associated with a condition of the container, analyzing the sensor data to determine whether the condition of the container indicates an abnormal condition for the container, identifying one or more of the train car, the container, a train to which the train car belongs, and a train symbol associated with the train, and generating an alert signal in response to a determination that the condition of the container indicates an abnormal condition. In embodiments, the alert signal includes one or more of the abnormal condition, an identification of the train car, an identification of the container, an identification of the train to which the train car belongs, and the train symbol associated with the train. In embodiments, the alert signal causes one or more remedial actions configured to respond to the abnormal condition of the container.

In yet another embodiment, a computer-based tool for intelligent detection of abnormal conditions associated with a shipping container is provided. The computer-based tool includes non-transitory computer readable media having stored thereon computer code which, when executed by a processor, causes a computing device to perform operations. The operations include detecting a presence of a container carried by a train car of a train within an inspection area, capturing sensor data associated with a condition of the container, analyzing the sensor data to determine whether the condition of the container indicates an abnormal condition for the container, identifying one or more of the train car, the container, a train to which the train car belongs, and a train symbol associated with the train, and generating an alert signal in response to a determination that the condition of the container indicates an abnormal condition. In embodiments, the alert signal includes one or more of the abnormal condition, an identification of the train car, an identification of the container, an identification of the train to which the train car belongs, and the train symbol associated with the train. In embodiments, the alert signal causes one or more remedial actions configured to respond to the abnormal condition of the container.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims, if any. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for intelligent detection of abnormal conditions associated with a shipping container in accordance with embodiments of the present disclosure.

FIG. 2 is a block diagram illustrating an example implementation of an on-site system with functionality for detecting abnormal conditions associated with a shipping container in accordance with embodiments of the present disclosure.

FIG. 3 is a block diagram illustrating an example implementation of a backend system with functionality for processing detecting abnormal conditions associated with a shipping container in accordance with embodiments of the present disclosure.

FIG. 4 illustrates an example of an abnormal condition detected by a system in accordance with embodiments of the present disclosure.

FIGS. 5A-5F illustrate various examples of image data including various examples of abnormal conditions that may be detected by a system configured with functionality for intelligent detection of abnormal conditions associated with a shipping container in accordance with embodiments of the present disclosure.

FIG. 6 shows a high-level flow diagram of operation of a system configured for intelligent detection of abnormal conditions associated with a shipping container in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for intelligent detection of abnormal conditions associated with a shipping container. In particular embodiments, a system may operate to capture sensor data associated with the container. The sensor data may include data associated with a condition of the container. The system may apply one or more models to the sensor data to detect the container within the sensor data, to classify the container, to filter out sensor data, to detect abnormal conditions of the container within the sensor data, and to generate one or more alerts in response to the detection of the abnormal conditions. In some embodiments, the system may utilize machine learning and artificial intelligence models to analyze the sensor data and identify potential security threats or operational issues related to the containers.

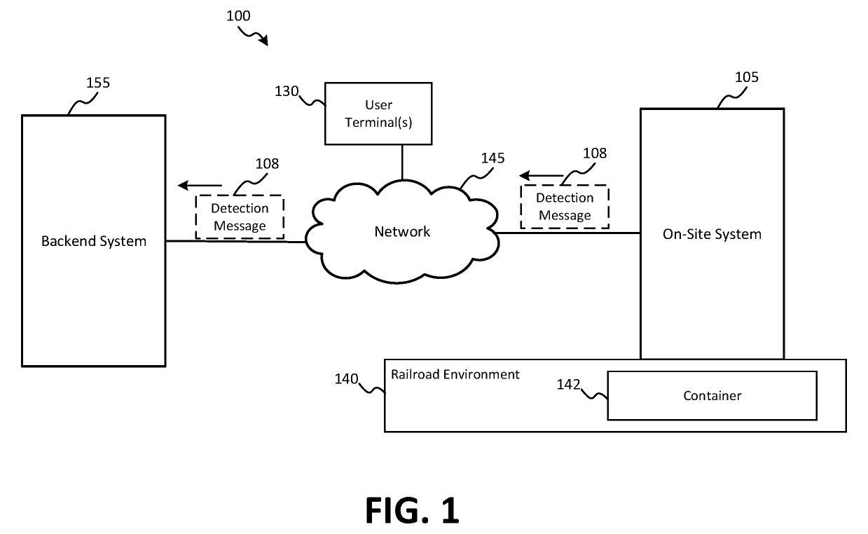

FIG. 1 is a block diagram of an exemplary system 100 configured with capabilities and functionality for intelligent detection of abnormal conditions associated with a shipping container in accordance with embodiments of the present disclosure. As shown in FIG. 1, system 100 may include user terminal 130, network 145, railroad environment 140, on-site system 105, and backend system 155. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145. It is also noted that some of the functional blocks of system 100 are illustrated as part of the on-site system 105, but in some embodiments, these components may be implemented in the backend system 155 without affecting their functionality. For example, in some embodiments, the classification manager 121 and the abnormal condition manager 122 may be implemented in the backend system 155. In some embodiments, functionality of a particular component may be distributed over the on-site system 110 and the backend system 155 in combination.

System 100 may be configured as an automated system for intelligent detection of abnormal conditions associated with shipping containers. In embodiments, system 100 may include functionality to utilize machine learning and/or artificial intelligence models to detect whether an abnormal condition is present in a container carried by a train car that is part of a train. The abnormal conditions detected by system 100 may include theft or tampering indicators, such as defects or other conditions that may indicate a likelihood of theft or tampering. In some embodiments, these abnormal conditions may include open doors, tampered seals (e.g., broken, replaced, missing, misplaced), tampered handles (e.g., hanging handles, handles not properly engaged), etc. in embodiments, when system 100 detects an abnormal condition, system 100 may generate an alert, report, and/or notification that may cause one or more remedial actions to be taken in response to the detected abnormal condition of the container. In some embodiments, the remedial actions may include a detailed manual inspection, a more in-depth automated analysis by one or more automated inspection systems, actuation of a physical component to sort the container out of the train, generating a report to be sent to the customer alerting them of the abnormal condition, resecuring the container, apprehending potential bad actors, etc. In embodiments, the functionality of system 100 may be obtained by the cooperative operation of the component of system 100, in accordance with the present embodiments.

The user terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, the user terminal 130 may provide a user interface that may be configured to provide an interface (e.g., a graphical user interface (GUI)) structured to facilitate an operator interacting with system 100, e.g., via network 145, to execute and leverage the features provided by system 100.

In embodiments, the user terminal 130 may be configured to receive and display reports, notifications, and/or alerts generated by system 100. In some embodiments, the user terminal 130 may present this information through the GUI in real-time as abnormal conditions are detected, or may be presented in non-real-time after the abnormal condition detection. The user terminal 130 may include functionality to categorize, filter, or prioritize incoming alerts based on severity or other criteria.

In some embodiments, an operator may be enabled to access a dashboard that may be generated by the I/O manager 174 of the backend system 155 using the user terminal 130. For example, the dashboard may be served to the user via the user terminal 130 and may provide an overview of abnormal detection information related to system 100. In embodiments, the user terminal 130 may allow operators to interact with the dashboard, enabling them to access specific details of abnormal condition detections, view historical data, generate custom reports, set configuration parameters (e.g., for detection, reports, etc.). In some embodiments, the user terminal 130 may provide functionality for users to acknowledge alerts, assign tasks, or initiate remedial actions directly through the interface. In some embodiments, the dashboard may include visual representations of data, such as charts, graphs, or maps, that illustrate trends or patterns in detected abnormal conditions.

In embodiments, the user terminal 130 may include secure authentication and authorization functionality, ensuring that only authorized personnel can access sensitive information or perform certain actions related o system 100. In additional or alternative embodiments, the user terminal 130 may include offline capabilities, allowing users to access previously downloaded reports or alerts even when network connectivity is unavailable. The user terminal 130 may synchronize data with the backend system 155 when a connection is reestablished.

In embodiments, the user terminal 130 may support push notifications, ensuring that critical alerts are immediately brought to the attention of relevant personnel, even when the user is not actively using the interface. The user terminal 130 may also provide customization options, allowing users to tailor the interface and notification settings to their specific roles and preferences.

In embodiments, the user terminal 130 may include functionality for capturing and uploading additional data, such as photos or notes, which can be associated with specific abnormal condition detections. This functionality may operate to assist in providing context or additional information for follow-up investigations or remedial actions.

In some embodiments, the user terminal 130 may include collaboration functionality, enabling multiple users to share information, communicate, coordinate responses to detected abnormal conditions, etc. This functionality may include integrated messaging or commenting systems within the GUI. In embodiments, the user terminal 130 may be configured to communicate with other components of system 100, such as via network 145, facilitating the exchange of information and control signals throughout the system.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

The railroad environment 140 may include infrastructure and operational components associated with a train yard, railroad track, and/or any environment related to the transportation of container over railroad. In embodiments, the railroad environment 140 may represent one or more railroad tracks configured to accommodate different types of trains and cargo, including those carrying shipping containers, such as container 142. In embodiments, the railroad environment 140 may include various security measures aimed at protecting the shipping containers in transit. For example, the railroad environment 140 may include physical barriers, surveillance systems, checkpoints at key locations, inspection areas where containers can be examined for signs of tampering or other security concerns, etc. In particular embodiments, the railroad environment 140 may include a physical portal through which trains may pass. This physical portal may be positioned along the railroad tracks and may operate as a point at which system 100 may operate to detect abnormal conditions associated with shipping containers. In embodiments, the physical portal may be configured to support the mounting of various components of system 100, such as one or more sensors and/or other equipment used by the on-site system 105 to capture data about the containers as they pass through.

System 100 may include an on-site system 105 and a backend system 155 that may cooperatively operate to provide functionality for intelligent detection of abnormal conditions associated with shipping containers. In embodiments, the on-site system 105 may be configured to capture and analyze sensor data related to the condition of one or more containers. The on-site system 105 may utilize this sensor data to detect abnormal conditions associated with the containers. In some embodiments, the on-site system 105 may determine identification data, which may include identifying the container with the detected abnormal condition, the train car carrying the container, and/or the train to which the train car belongs. Based on this analysis, the on-site system 105 may generate a detection message 108 that includes the detected abnormal condition and/or the identification data. The backend system 155 may be configured to receive and process the detection messages 108 generated by the on-site system 105. In some embodiments, the backend system 155 may handle various aspects of alert management, reporting, and initiation of remedial actions in response to the detected abnormal conditions. The backend system 155 may analyze the received detection messages, correlate the information with other data sources, and generate appropriate alerts or reports. In some embodiments, the backend system 155 may trigger automated responses or notify relevant personnel to take specific remedial actions based on the nature and severity of the detected abnormal conditions.

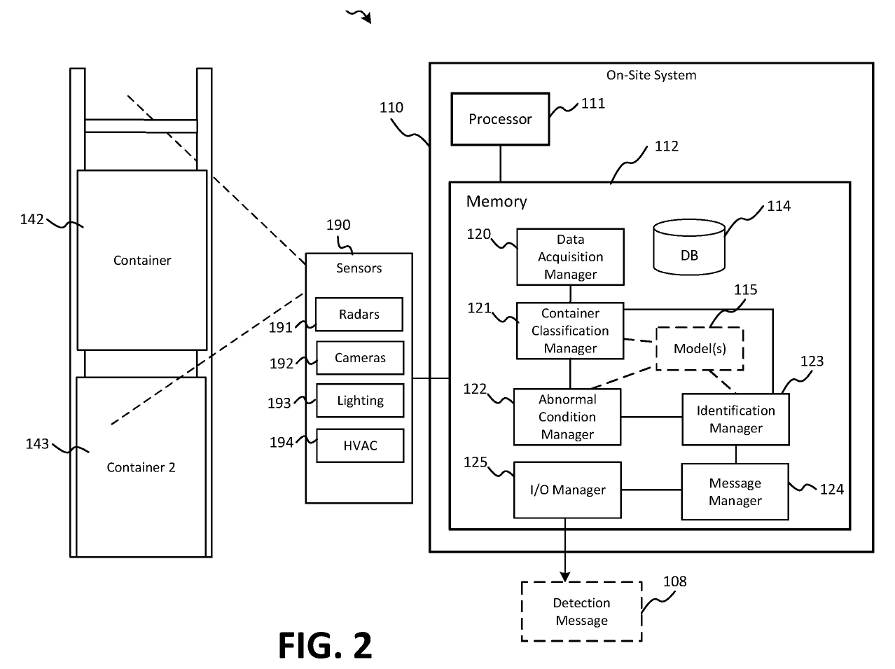

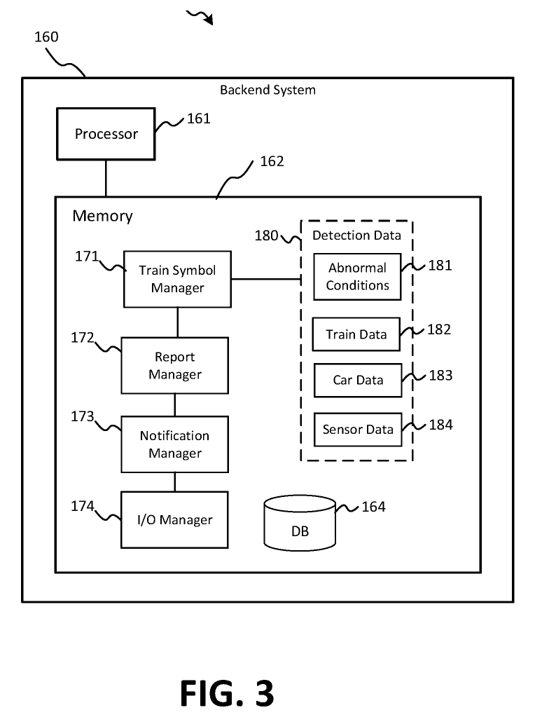

The specific implementation and functionality of the on-site system 105 and the backend system 155 will now be discussed with reference to FIGS. 2 and 3, respectively. FIG. 2 is a block diagram illustrating an example implementation of on-site system 105 with functionality for detecting abnormal conditions associated with a shipping container in accordance with embodiments of the present disclosure. As shown in FIG. 2, the on-site system 105 may be implemented in a server (e.g., server 110). In embodiments, functionality of server 110 to facilitate operations of the on-site system 105 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, the on-site system 105 may include one or more sensors 190 and server 110. Server 110 may include processor 111, memory 112, data acquisition manager 120, container classification manager 121, abnormal condition manager 122, identification manager 123, message manager 124, input/output (I/O) manager 125, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise a database 114 for storing various information related to operations of system 100. For example, the database 114 may store configuration information related to operations of the on-site system 105. In embodiments, the database 114 may store information related to various models 115 used during operations of the on-site system 105, such as a container classification model configured to detect containers in sensor data and determine a type of the detected container, a container door detection model configured to detect a door of the container within the sensor data, an abnormal condition detection model configured to determine whether the container detected in the sensor data includes an abnormal condition, a container identification model configured to detect an identification of the container detected in the sensor data, a train car identification model configured to detect an identification of the train car carrying the container detected in the sensor data, a train identification model configured to detect an identification of the train to which the train car belongs, etc.

In embodiments, the database 114 may store all abnormal condition detections, whether valid or not. In other embodiments, the database 114 may store only validated abnormal condition detections. In some embodiments, the database 114 may store the detection messages generated by the on-site system 105. In additional or alternative embodiments, the database 114 may be configured to store image data related to container detection and classifications, and/or image data associated with abnormal condition detections. This stored data may be used for various purposes, such as historical analysis, model training, or verification of system performance.

Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

In some embodiments, the on-site system 105 may be configured as an edge computing system. This edge configuration may allow for processing of sensor data and execution of machine learning and artificial intelligence models directly at the site where the data is captured and generated (e.g., at the location of the on-site system 105), rather than relying on a centralized server or cloud-based system. This edge computing implementation of the on-site system 105 may offer several technical advantages. For example, by implementing the on-site system 105 as an edge computing system, the latency in data processing and decision-making may be reduced, as the sensor data does not need to be transmitted to a remote location for analysis. This may be particularly beneficial in embodiments where rapid detection and response to abnormal conditions may be critical.

The edge computing configuration of the on-site system 105 may also enable the on-site system 105 to operate in environments with limited or unreliable network connectivity. For example, since the on-site system 105 can process data locally, the on-site system 105 may continue to function effectively even in situations where communication with the backend system 155 is disrupted. In some embodiments, the edge computing configuration of the on-site system 105 may allow the edge-based on-site system 105 to use a lightweight communication protocol for interactions with the backend system 155. This streamlined protocol may focus on transmitting only essential information, such as validated abnormal condition detections and summary statistics, rather than raw sensor data, although raw sensor data may also be transmitted in some embodiments. This may reduce bandwidth requirements and improve overall system efficiency.

In some embodiments, implementing the on-site system 105 as an edge computing system may enable the on-site system 105 to utilize dedicated hardware optimized for running machine learning and artificial intelligence models. This may include specialized processors or accelerators designed for efficient execution of neural networks and other complex algorithms used in container classification and abnormal condition detection. The edge configuration may also enable the on-site system 105 to update its machine learning models based on local data, even while periodically synchronizing with the backend system 155 to share results and/or receive global model updates. This may enable the on-site system 105 to adapt to local conditions while maintaining consistency across multiple deployment sites.

In some embodiments, the edge-based on-site system 105 may include local data storage (e.g., database 114). This local data storage functionality may allow the on-site system 105 to retain historical data for long periods of time, which may enable offline analysis and may provide a buffer in case of communication failures with the backend system 155.

In some embodiments, implementing the on-site system 105 as an edge computing system may enable the on-site system 105 to be modularly expanded. For example, additional and/or alternative components, such as additional sensors, newer sensors, additional and/or different processing units, etc., may be integrated into the on-site system 105 as needed or desired.

The methodology of the implementation of the on-site system 105 may employ a two-stage approach for detecting abnormal conditions associated with shipping containers. This two-stage approach may be configured to enhance the efficiency, accuracy, precision, and utility of the abnormal condition detection functionality of the on-site system 105 by processing captured sensor data in separate and distinct stages.

In embodiments, the first stage of the two-stage approach may include application of a container classification process. In this stage, the container classification manager 121 may utilize a container classification model stored in the models 115 of database 114 to analyze the sensor data, such as image data captured by cameras 192, to identify and classify containers within the data. The classification process may operate to detect containers in the sensor data, determine the type of the detected containers, filter out sensor data (e.g., image data) that do not include the desired type of container. For example, if the system 100 is configured to detect abnormal conditions in intermodal containers, the container classification model may filter out images that do not include intermodal containers or that contain other types of containers or cargo.

In the second stage of the two-stage approach, the abnormal condition manager 122 may apply one or more models, which may be stored in the models 115 of database 114, to perform several tasks on the filtered data from the first stage. For example, the abnormal condition manager 122 may apply a door detection model stored in the models 115 to the filtered sensor data, which may include analyzing the image data including the detected container to locate and identify the specific area of the container where the door is located. The abnormal condition manager 122 may apply an abnormal condition model (e.g., stored in the models 115 of database 114) to assess the condition of the detected door and/or components associated with the door (e.g., handles, locks, etc.) to determine whether an abnormal condition is present. This assessment may include analyzing various aspects of the door and/or components associated with the door, such as appearance and position. Based on this assessment, the abnormal condition manager 122 may determine whether the condition of the door and/or components associated with the door indicates an abnormal condition.

The abnormal conditions that may be detected may include, but are not limited to, open doors, tampered seals (e.g., broken, replaced, missing, misplaced), tampered handles (e.g., hanging handles, handles not properly engaged), broken locks, misaligned container components, unusual wear patterns, signs of forced entry, missing security tags, damaged container walls or doors, unexplained holes or openings, loose or missing bolts/fasteners, signs of repainting or repair work, presence of unauthorized markings or labels, unusual weight discrepancies, etc. In some embodiments, the abnormal condition detection model may be trained to recognize a wide range of indicators that may suggest the container has been subject to unauthorized access or theft attempts. For example, the model may detect subtle signs of forced entry, misaligned components, unusual wear patterns that may not be immediately apparent to human inspectors, cargo outside a container, etc. In some embodiments, the abnormal condition manager 122 may utilize multiple specialized models within this second stage. For example, there may be separate models for door detection, seal integrity assessment, handle integrity analysis, etc.

The two-stage approach of embodiments may provide several benefits. For example, by filtering out irrelevant data in the first stage, the on-site system 105 may reduce the computational load on the more complex abnormal condition detection processes in the second stage. This may allow for faster processing times and more efficient use of the on-site system 105’s resources. Additionally, the multi-staged approach may help to minimize false positives by ensuring that only relevant container types are subjected to detailed abnormality analysis.

In some embodiments, the on-site system 105 may be configured to adapt its detection parameters based on feedback from the backend system 155 or historical data stored in database 114. This may allow the on-site system 105 to improve its accuracy over time and adjust to new types of abnormal conditions or theft techniques that may emerge.

The one or more sensors 190 may be configured to capture sensor data associated with the containers. For example, the one or more sensors 190 may operate continuously or intermittently (e.g., in response to a trigger to activate them) to collect data on the physical characteristics and conditions of the containers (e.g., container 142 and/or container 143) as they pass through the inspection area. The sensor data captured by the one or more sensors 190 may include visual imagery (e.g., images, pictures, videos, etc.), thermal readings, weight measurements, dimensional data, or other types of information that can be used to assess the condition of the containers. In embodiments, the sensor data may be used by the components of the on-site system 105 for detecting potential abnormalities or security breaches in the containers. By capturing detailed sensor data, the one or more sensors 190 may enable the on-site system 105 to perform thorough analyses and identify indicators of tampering or theft that may not be apparent through visual inspection alone. The sensor data collected by the one or more sensors 190 may enable the system 100 to accurately detect and report abnormal conditions associated with the containers, which may improve the security and integrity of the transportation process.

In embodiments, the one or more sensors 190 may include one or more radars 191. The one or more radars 191 may be configured to detect the presence of a train, train car, and/or containers (e.g., within an inspection area). For example, the one or more radars 191 may detect the presence of container 142 within the area of inspection. This detection by the one or more radars 191 may be used (e.g., by data acquisition manager 120) as a trigger to begin the process for capturing additional sensor data and detecting abnormal conditions associated with the containers. In embodiments, the one or more radars 191 may be communicatively coupled with the data acquisition manager 120 and may provide a signal indicating whether the presence of a train, train car, and/or container is detected by the one or more radars 191. In this manner, the data acquisition manager 120 may trigger the data collection and abnormal condition detection processes when the signal from the one or more radars 191 indicates that the presence of train, train car, and/or container (e.g., within the inspection area) has been detected.

In some embodiments, the one or more radars 191 may be configured to determine the direction of travel of the container, train car, and/or train. This functionality may enable the on-site system 105 to initiate data capture at an appropriate time to obtain sensor data for each container passing through the inspection area. By detecting the direction of travel, the on-site system 105 may anticipate the arrival of containers and prepare for data capture accordingly. In some embodiments, the one or more radars 191 may provide information on the speed of the train, which may allow the on-site system 105 to adjust its data capture rate or resolution. The one or more radars 191 may operate continuously or intermittently, and in some cases, may work in conjunction with other sensors. For example, the one or more radars 191 may be used in combination with optical sensors, cameras, or light detection and ranging (LIDAR) to enhance the accuracy of train and container detection. In some embodiments, the data from the one or more radars 191 may be processed by the data acquisition manager 120 to optimize the timing and duration of data capture from other sensors of the one or more sensors 190, such as the one or more cameras 192.

The one or more sensors 190 may include one or more cameras 192 configured to capture image data of the containers, train cars, and/or trains passing through the inspection area. In embodiments, the image data captured by the one or more cameras 192 may include still images, pictures, and/or videos.

In some embodiments, the one or more cameras 192 may include a camera array that is able to capture image data from multiple angles concurrently. For example, a first camera of the camera array may be oriented to capture images from the left side, a second camera may be oriented to capture images from the right side, and a third camera may be oriented to capture images from the center. This configuration may allow the one or more cameras 192 to capture each side of the container 142 (e.g., the front, side, and/or rear of the container 142), which may be used to detect and classify the container 142, to detect a door of container 142, to identify the container 142, and/or to determine whether there are abnormal conditions associated with the container 142 (e.g., indications of theft conditions or tampering, such as open doors, tampered seals, tampered handles, etc., and/or to identify the container 142 and/or the train car). In some embodiments, the different cameras of the camera array of the one or more cameras 192 may capture overlapping portions of the container 142, which may then be digitally combined into a single composite image for further processing. This may provide a more comprehensive view of the container 142 for analysis.

In some embodiments, the one or more cameras 192 may include high-resolution sensors to capture fine details that may be indicative of tampering or other abnormal conditions. In some embodiments, the one or more cameras 192 may be disposed on both sides of the railroad track 430 in the inspection area. This configuration may enable the system to capture sensor data from either side of the container being inspected, which may be particularly useful in multi-track environments where another passing train may obstruct the view of the container 142 from one side or the other.

In some embodiments, the one or more cameras 192 may be mounted on adjustable platforms that can be repositioned to optimize the viewing angle based on the specific layout of the inspection area. In some embodiments, the one or more cameras 192 may include specialized lenses or filters to enhance image quality under various lighting conditions. For example, polarizing filters may be used to reduce glare from reflective surfaces on the containers. In some embodiments, the one or more cameras 192 may include infrared or thermal imaging capabilities to detect temperature anomalies that may indicate unauthorized access or hidden compartments within the containers. In some embodiments, the data acquisition manager may include functionality that operates in conjunction with the one or more cameras 192 to enhance image quality, correct for distortions, highlight areas of interest for further analysis, etc.

In embodiments, the one or more sensors 190 may include lighting 193 configured to illuminate the inspection area including the area from which the image data is obtained by the one or more cameras 192. In embodiments, the lighting 193 may include various types of light sources, such as LED lights, floodlights, strobe lights, etc. depending on the specific requirements of the system 100 and the environmental conditions in which the on-site system 105 is configured to operate. In some embodiments, the lighting 193 may be adjustable to provide optimal illumination for different container types, weather conditions, and/or times of day.

In some embodiments, the lighting 193 may be synchronized with the one or more cameras 192 to ensure proper exposure and image quality at the appropriate timing. In some embodiments, the lighting 193 may include infrared illuminators to enable night vision functionality. The positioning and intensity of the lighting 193 may be configured to minimize glare or shadows that may interfere with image analysis. In some embodiments, the lighting 193 may be controlled by the data acquisition manager 120 to activate only when a container 142 is detected within the inspection area, which may operate to conserve and save energy.

In embodiments, the one or more sensors 190 may include an air conditioning unit 194 configured to regulate the temperature of components within the on-site system 105. In some embodiments, the air conditioning unit 194 may be configured to provide and maintain optimal operating temperatures for various components of the on-site system 105, such as the processor 111, memory 112, and/or one or more sensors 190. By controlling the thermal environment, the air conditioning unit 194 may help ensure reliable performance of the on-site system 105, particularly in challenging weather conditions or high-temperature environments.

In some embodiments, the air conditioning unit 194 may include temperature sensors to monitor the internal environment of the on-site system 105 and to make adjustments of cooling output based on real-time or near real-time temperature readings. In some embodiments, the air conditioning unit 194 may include additional functionality to manage and/or control humidity and dust levels within the on-site system 105. In some embodiments, the air conditioning unit 194 may be communicatively coupled to the data acquisition manager 120 to allow for coordinated operation with other system components and enable remote monitoring and control of the cooling system.

In embodiments, the one or more sensors 190 may include other types of sensors configured to capture different data and information for abnormal condition detection. In some embodiments, the one or more sensors 190 may include radio-frequency identification (RFID) readers that may automatically detect and identify containers equipped with RFID tags. In some embodiments, the one or more sensors 190 may include ultrasonic sensors configured to measure distances or detect structural anomalies in containers. Some embodiments may include the use of infrared cameras as part of the one or more sensors 190 to capture thermal images that may reveal hidden compartments or unauthorized access.

In some embodiments, the one or more sensors 190 may include weight sensors configured to detect the weight of train cars and/or containers, which may be used to detect unusual or abnormal weights (e.g., weights that deviate from expected weights) and/or unusual or abnormal weight distributions (e.g., different from expected weight distributions, such as the rear of a container being lighter than the front or lighter than expected) that may indicate tampering.

In some embodiments, the one or more sensors 190 may include vibration sensors configured to detect abnormal movements or disturbances of the containers and/or train cars, such as during movement as they pass the inspection area. In some embodiments, the one or more sensors 190 may include chemical sensors configured to detect the presence of unauthorized substances, or residues of substances that may be used for tampering or may be indicative of tampering. In some embodiments, the one or more sensors 190 may be configured to work in conjunction with each other, which may operate to provide a more comprehensive view of the condition of the containers being inspected and that can be used for abnormal condition detection.

The data acquisition manager 120 may be configured to manage and control the capture of sensor data by the one or more sensors 190 and to process the captured sensor data for further analysis. In embodiments, the data acquisition manager 120 may be configured to interface with the one or more sensors 190, and may operate to coordinate the data collection process and to ensure that all relevant sensor data is captured and processed efficiently. In some embodiments, the data acquisition manager 120 may use adaptive sampling techniques, which may enable the data acquisition manager 120 to adjust the data capture rate or resolution based on factors such as train speed, environmental conditions, detected anomalies, etc.

In embodiments, the data acquisition manager 120 may include triggering functionality that may utilize inputs from the one or more sensors 190 to detect the presence of a train, train car, and/or container within the inspection area. For example, the data acquisition manager 120 may use the inputs from the one or more radars 191 to detect the presence of a train, train car, and/or container within the inspection area. When the presence of a train, train car, and/or container is detected within the inspection area, the data acquisition manager 120 may activate sensors of the one or more sensors 190, such as the one or more cameras 192 and other sensors configured to capture data from the containers, to being capturing sensor data associated with the container. The sensor data may include image data captured by the one or more cameras 192.

In some embodiments, the data acquisition manager 120 may continue sensor data capture until the data acquisition manager 120 determines, such as based on input from the one or more radars 191, that a train, train car, and/or container is no longer present within the inspection area. In some embodiments, the data acquisition manager 120 may include a time-out feature that maintains sensor activation for a predetermined period after the presence of the train, train car, and/or container is no longer detected before deactivating the capture sensors.

In embodiments, once triggered, the data acquisition manager 120 may collect sensor data from the various activated sensors of the one or more sensors 190. This may include image data from the one or more cameras 192, weight measurements from integrated scales, thermal imaging data, RFID readings, LIDAR scans, ultrasonic sensor data, and/or information from any other sensors included in the one or more sensors 190.

In some embodiments, the data acquisition manager 120 may coordinate the operation of different sensors to optimize data collection. For example, the data acquisition manager 120 may synchronize the activation of the lighting 193 with the image capture by the one or more cameras 192 to ensure proper illumination. In some embodiments, the data acquisition manager 120 may adjust sensor parameters based on environmental conditions or the speed of the train, which may be determined from the radar data from the one or more radars 191.

In embodiments, the data acquisition manager 120 may include functionality to pre-process the collected sensor data. This pre-processing may include tasks such as noise reduction, image enhancement, data compression, initial filtering of irrelevant information, etc. In some embodiments, the data acquisition manager 120 may combine data from multiple sensors of the one or more sensors 190 to create a more comprehensive dataset for each container.

In some embodiments, the data acquisition manager 120 may be configured to parse the image data from different cameras of the one or more cameras 192 for use by different models for different purposes. For example, in some implementation of containers, the doors of the containers may be located at one end of the container, rather than on the side of the container. In these cases, the identification of the container may be on the side of the container or on the doors. The data acquisition manager 120 may be configured to parse the image data from the one or more cameras 192 such that the image data from the camera configured to capture the side view of the container is separated from the image data from the cameras configured to capture the ends of the containers. The data acquisition manager may provide the side view camera image data to the identification manager 123, rather than the abnormal condition manager 122. This may allow the identification manager 123 to use the side view image data containing the container identification information to identify the container.

In some embodiments, the data acquisition manager 120 may implement adaptive routing of image data based on container configuration. For example, the identification image data from the side view camera may be provided to the container classification manager 121, with an indication that it is side view camera image data, to verify that the container is a type being analyzed. If the container classification manager 121 determines the container is a type to be inspected, the side view camera image data may then be transmitted to the identification manager 123. In cases where doors may be on the side of the container, the side view camera image data may still be provided to the abnormal condition manager 122 for abnormal condition detection. In embodiments, the image data from the end view cameras may be fed to the abnormal condition manager 122, as this image data may include a view of the container doors. The abnormal condition manager 122 may use this end view camera image data to detect the location of the container doors and/or to determine whether the containers have an abnormal condition.

In some embodiments, the data acquisition manager 120 may employ machine learning algorithms to dynamically adjust its data routing based on patterns observed in container configurations and abnormal condition detections. The data acquisition manager 120 may also implement data fusion techniques to combine information from multiple camera views, which may provide a more comprehensive view and analysis for each container. For example, the data acquisition manager 120 may correlate side and end view data to create an end-to-end representation of the container, which may include a view of the container from one end to the other. In some embodiments, the data acquisition manager 120 may prioritize certain types of image data based on real-time factors such as environmental conditions, time of day, specific security alerts, etc., such as to allow the on-site system to focus its processing resources on the most relevant or high-risk aspects of each container inspection.

The container classification manager 121 may be configured to detect the presence of a container within the sensor data (e.g., detect a container within the image data), classify the detected container (e.g., classify the detected container into a type of container), and/or to filter out sensor data that is not associated with a type of container being inspected. In this manner, the container classification manager 121 is configured to implement the first stage of the two-stage approach.

In embodiment, the container classification manager 121 may be configured to utilize one or more models of the models 115 to analyze the sensor data received from the data acquisition manager 120. In some embodiments, the one or more models 115 may represent machine learning and/or artificial intelligence models trained to recognize and classify different types of shipping containers. The container classification manager 121 may process the incoming sensor data, which may include image data from the one or more cameras 192, to identify the presence and boundaries of containers within the field of view included in the image data. For example, in embodiments, the container classification manager 121 may detect the presence of any container-like objects within the sensor data. This container detection may use object detection techniques (e.g., using a container detection model of models 115 configured to detect containers in sensor data) to identify potential containers based on their shape, size, and/or other visual characteristics.

Once a container has been detected within the sensor data, the container classification manager 121 may use a container classification model of models 115 to classify the detected container into a specific type, such as an intermodal container, a box container, a tanker container, a refrigerated container, etc.

In embodiments, the container detection model and/or the container classification model used by the container classification manager 121 may be periodically updated to improve their accuracy and adapt to new container types or variations. In some embodiments, the container detection model and/or the container classification model may be fine-tuned using transfer learning techniques, allowing them to quickly adapt to specific operational environments or new container configurations.

In addition to visual data, the container classification manager 121 may include data from other sensors of the one or more sensors 190 to enhance the accuracy of the container detection model and/or the container classification model. For example, weight data from integrated scales may be used to corroborate the visual classification, as different container types may have characteristic weight ranges. Similarly, thermal imaging data may be used to distinguish between refrigerated and non-refrigerated containers.

In embodiments, the container classification manager 121 may filter out sensor data that is not associated with a type of container being inspected. This filtering functionality may include foregoing further processing of sensor data associated with container types that are not the focus of the current inspection. For example, the container classification manager 121 may filter out images that include containers classified as types other than the container type being inspected. For example, the on-site system 105 may be currently configured to inspect intermodal containers (e.g., may be configured to detect abnormal conditions for only intermodal containers). This example, the container classification manager 121 may filter out images that do not contain intermodal containers. For example, sensor data including containers that are not intermodal containers, or that are not containers, may be filtered out in this example.

In embodiments, filtering out sensor data may include excluding the filtered sensor data from subsequent analysis steps. In embodiments, when the container classification manager 121 detects and classifies a container as a type being inspected, the container classification manager 121 may transmit the associated sensor data to the abnormal condition manager 122 for further analysis.

In embodiments, the filtering functionality of the container classification manager 121 may operate to optimize the on-site system 105’s processing. For example, by identifying and filtering out sensor data related to container types that are not of interest for the current inspection task, the container classification manager 121 may reduce the computational load on subsequent processing stages. This filtering may be dynamically configurable, allowing operators to adjust the types of containers that are flagged for inspection based on current security priorities or operational needs.

In some embodiments, the container classification manager 121 may maintain a confidence score for each classification decision. When the confidence score falls below a certain threshold, the container classification manager 121 may flag the container for manual review or additional sensor data collection. This approach may help to minimize false negatives in the classification process, which may ensure that potentially important containers are not inadvertently filtered out. In some embodiments, containers may be flagged for manual review or additional sensor data collection regardless of the confidence score. In some embodiments, issues that may prompt manual review may include not being able to detect an ID, a determination that the ID is not in an internal database, a determination that the container includes high priority freight, etc.

In some embodiments, the container classification manager 121 may include functionality to handle partial occlusions or non-standard container orientations. In cases where a container is partially obscured by another object or presented at an unusual angle, the container classification manager 121 may be configured to make best-effort classifications based on the visible portions of the container.

In some embodiments, the container classification manager 121 may work in conjunction with the data acquisition manager 120 to optimize sensor data collection. For example, if the initial classification of a container is uncertain, the container classification manager 121 may request additional sensor data or higher resolution images from specific angles to improve classification accuracy.

In embodiments, the container classification manager 121 may be configured to establish connections with external databases or information systems that contain relevant data about the containers, their contents, their shipping status, etc. These databases may include inventory management systems, shipping manifests, and/or other logistics-related information repositories. By cross-referencing the detection of a container within the sensor data, or the sensor data itself, with this additional data, the container classification manager 121 may validate a container detection and/or may more precisely detect the presence of a container within the sensor data.

The abnormal condition manager 122 may be configured to detect whether the container in the sensor data includes an abnormal condition. In this manner, the abnormal condition manager 122 may be configured to implement the second stage of the two-stage approach. The functionality of abnormal condition manager 122 to detect whether the container in the sensor data includes an abnormal condition may include several steps leveraging different models of the models 115 of database 114.

For example, in a particular embodiment, detecting whether the container in the sensor data includes an abnormal condition may include detecting a container door of the container detected in the senso data. Detection of the container door may include using a container door detection model of the models 115. This container door detection model may be configured to analyze the sensor data, such as image data from the one or more cameras 192, to locate and identify the specific area of the container where the door is located. In some embodiments, the container door detection model may mark the detected container door in the sensor data with a bounding box.

In embodiments, detecting whether the container in the sensor data includes an abnormal condition may include, once the door is detected, assessing the condition of the detected door and/or components associated with the door, such as handles, locks, or seals. This assessment may include analyzing various aspects of the door and its components, including their appearance, position, and integrity, using an abnormal condition detection model of the models 115. The abnormal condition manager 122 may use the abnormal condition detection model to determine whether the condition of the door and/or the components associated with the door indicates an abnormal condition. The abnormal condition detection model may be configured to analyze the assessed condition of the door and its components. The abnormal condition detection model may be trained to recognize a wide range of indicators that may suggest the container has been subject to unauthorized access or theft attempts.

In some embodiments, the abnormal conditions that may be detected by the abnormal condition manager 122 may include, but are not limited to, open doors, tampered seals (e.g., broken, replaced, missing, misplaced), tampered handles (e.g., hanging handles, handles not properly engaged), broken locks, misaligned container components, unusual wear patterns, signs of forced entry, missing security tags, damaged container walls or doors, unexplained holes or openings, loose or missing bolts/fasteners, signs of repainting or repair work, presence of unauthorized markings or labels, unusual weight discrepancies, etc. In embodiments, the abnormal condition detection model may be configured to detect subtle signs of forced entry, misaligned components, or unusual wear patterns that may not be immediately apparent to human inspectors. In some embodiments, the abnormal condition detection model may analyze patterns in the sensor data that correspond to known indicators of tampering or theft attempts.

In embodiments, the abnormal condition detection model used by the abnormal condition manager 122 may be trained to recognize abnormal conditions from normal conditions using various machine learning techniques. In some embodiments, the abnormal condition detection model may analyze multiple features of container components to determine whether these container components have been tampered with or compromised. For example, the abnormal condition detection model may examine the shape, color, and/or size of container seals to assess whether these seals are likely to have been tampered with. A broken or replaced seal may exhibit characteristics such as an unusual color, irregular shape, or improper dimensions that deviate from the expected parameters of an intact seal.

In another example, the abnormal condition detection model may be trained to recognize that the container door is opened, partially or fully. The abnormal condition detection model may be trained on a large dataset of images showing both closed and open (e.g., fully opened or partially open) container doors to accurately distinguish between these states.

In yet another example, the abnormal condition detection model may be trained to recognize tampered handles on container doors. The abnormal condition detection model may analyze the shape, color, size, and orientation of the handles to determine whether these handles are in an abnormal state. For example, a handle that is hanging loosely or not properly engaged with the container may indicate that the container has been opened or tampered with. The abnormal condition detection model may be trained on a large dataset of images showing both normal and abnormal handle positions to accurately distinguish between these states.

In embodiments, the abnormal condition detection model may utilize image segmentation techniques to break down the sensor data into individual pixels or groups of pixels. This approach may allow for more granular analysis of the container’s features. In these embodiments, after segmentation, the abnormal condition detection model may apply pattern recognition algorithms to identify specific patterns or anomalies that may indicate an abnormal condition. For example, the abnormal condition detection model may detect unusual patterns in the texture of a container’s surface that may suggest an open container door, unauthorized modifications, attempts to conceal tampering, etc.

In some embodiments, the abnormal condition manager 122 may include functionality to score the features of the abnormal condition detection model. For example, in embodiments, the abnormal condition detection model may assign scores to various features or patterns detected in the sensor data based on their likelihood of indicating an abnormal condition. These scores may be compared against predefined thresholds to determine whether an abnormal condition is to be flagged. For example, if the cumulative score for a particular set of detected features exceeds a certain threshold, the abnormal condition manager 122 may determine this to be an abnormal condition detection.

In embodiments, the thresholds used by the abnormal condition manager 122 may be dynamically adjustable based on various factors such as the type of container, the route, historical data, etc. In some embodiments, the abnormal condition manager 122 may employ different thresholds for different types of abnormal conditions, allowing for more nuanced detection capabilities. The use of thresholds may operate to balance the sensitivity of the abnormal condition detection to minimize false positives while ensuring that potential signs of theft and/or tampering are not missed.

In some embodiments, the abnormal condition manager 122 may utilize ensemble learning techniques, combining multiple models or algorithms to improve overall detection accuracy. In these embodiments, each model in the ensemble may specialize in detecting specific types of abnormalities or analyzing particular aspects of the container. The outputs from these individual models may be aggregated to produce a final assessment of the container’s condition, which may increase the accuracy and reliability of the abnormal condition detection functionality of the abnormal condition manager 122.

For example, in some embodiments, the abnormal condition manager 122 may utilize multiple specialized models for detecting an abnormal condition within a container. There may be separate models for door detection, seal integrity assessment, handle integrity analysis, and other specific aspects of container security. In embodiments, the abnormal condition manager 122 may process the sensor data using these specialized models in parallel or in a sequential manner, depending on the specific implementation and computational resources available. In some embodiments, the results from one specialized model may inform the processing or interpretation of results from another specialized model.

In some embodiments, the abnormal condition manager 122 may assign confidence scores to the abnormal condition detections. These scores may reflect the degree of certainty in the detection of an abnormal condition. The system 100 (e.g., the backend system 155) may use these confidence scores to prioritize alerts or to determine whether additional inspection or verification is needed.

In embodiments, the abnormal condition manager 122 may include feedback functionality configured to enable the abnormal condition manager 122 to learn and adapt over time. For example, in some embodiments, the abnormal condition manager 122 may include functionality to receive and incorporate feedback from human operators or from the outcomes of subsequent physical inspections to refine its detection capabilities. This adaptive learning may help the abnormal condition manager 122 to improve its accuracy and to stay current with new types of tampering or theft techniques that may emerge. In some embodiments, the abnormal condition manager 122 may include functionality to correlate abnormal condition detections with historical data or patterns stored in the database 114 in order to identify trends or recurring issues with specific containers, routes, time periods, etc. This functionality may enable the abnormal condition manager 122 to adjust its analysis based on factors such as time of day, weather conditions, the specific characteristics of the inspection area, the containers, etc.

In some embodiments, the abnormal condition manager 122 may work in conjunction with other components of the on-site system 105 to provide enhanced analysis. For example, the abnormal condition manager 122 may correlate abnormal condition detections with data from the identification manager 123 to associate detected abnormal conditions with specific containers, train cars, and/or trains.

In embodiments, the abnormal condition manager 122 may include functionality to validate detected abnormal conditions. This may include reconciling and/or confirming the detected abnormal conditions with other relevant data related to the container with the detected abnormal condition. In embodiments, this functionality of the abnormal condition manager 122 may operate to verify whether the detected abnormal condition is genuinely indicative of potential theft or unauthorized access and not something innocent. In embodiments, the abnormal condition manager 122 may access and analyze supplementary information from various sources to provide context for the detected abnormal conditions.

For example, the abnormal condition manager 122 may establish connections with external databases or information systems that contain relevant data about the containers, their contents, their shipping status, etc. These databases may include inventory management systems, shipping manifests, and/or other logistics-related information repositories. By cross-referencing the detected abnormal condition with this additional data, the abnormal condition manager 122 may gain a better understanding of the container’s status and the potential significance of the detected abnormality.

In some embodiments, the abnormal condition manager 122 may determine that a container flagged with an abnormal condition is actually in a state that would explain the detected abnormal condition without indicating theft or tampering. For example, if the abnormal condition manager 122 detects an abnormal condition on a container, but the connected database indicates that the container is actually empty, the abnormal condition manager 122 may not validate the abnormal condition but may rather determine this condition as a normal operational state rather than an indication of theft or tampering. On the other hand, if the connected database does not indicate a condition that would explain the open door, then the abnormal condition manager 122 may validate the abnormal condition (e.g., the open door) as an indication of theft or tampering. In another example, if the abnormal condition manager 122 detects an open door or a loose seal on a container, but the connected database indicates that the container is scheduled for loading or unloading at that time, the abnormal condition manager 122 may interpret this as a normal operational state rather than an indication of theft and may not validate the detected abnormal condition. On the other hand, if the connected database does not indicate a status that would explain the open door or loose seal, then the abnormal condition manager 122 may validate the abnormal condition (e.g., the open door or loose seal) as an indication of theft or tampering.

The abnormal condition manager 122 may define criteria for what constitutes an invalid abnormal condition and what constitutes a valid abnormal condition. These criteria may include situations where a detected abnormal condition can be explained by legitimate operational activities or where the container’s known status renders the detected abnormal condition non-threatening. For example, an empty container with an open door may not be considered an abnormal condition requiring immediate attention, even though the same situation for a loaded container might be considered an indication of tampering and/or theft.

In some embodiments, the abnormal condition manager 122 may assign different levels of severity or urgency to detected abnormalities based on the results of the validation process. For example, a detected open door on a container known to be empty may be flagged as a low-priority issue for routine inspection, while the same condition on a container known to be carrying high-value goods may trigger an immediate high-priority alert.

In embodiments, the abnormal condition manager 122 may include historical data and patterns into the validation functionality. For example, if a particular type of abnormal condition has been frequently detected on a specific route or at a specific time of day, and subsequent investigations have consistently found these to be false alarms, the abnormal condition manager 122 may learn to invalidate these types of abnormal condition when detected under similar conditions.

In embodiments, the output of the abnormal condition manager 122 may be provided to the identification manager 123 and/or the message manager 124 for further processing.

The identification manager 123 may be configured to detect identification data related to the container including the detected abnormal condition. In embodiments, the identification data may include an identification of one or more of the container (e.g., the container having the abnormal condition), the train car in which the container is being transported, and/or the train to which the train car belongs. In some embodiments, the identification manager 123 may utilize one or more models from models 115 trained to detect and extract identification information from the sensor data captured by the one or more cameras 192 and/or other sensors of the one or more sensors 190.

In embodiments, the identification manager 123 may use a container identification model of models 115 configured to detect and recognize the identification of containers detected in the sensor data. This container identification model may be trained on a large dataset of container images to recognize various types of container markings, including alphanumeric codes, barcodes, QR codes, and/or other identification systems commonly used in the shipping industry. In some embodiments, the container identification model may be configured to recognize and interpret multiple identification formats, which may allow for flexibility in handling containers from different shipping companies and/or countries.

In a particular embodiment, the identification manager 123 may use image data from the one or more cameras 192 to determine the identification of the container. This may include applying optical character recognition (OCR) techniques to extract alphanumeric codes from container surfaces. The identification manager 123 may be configured to process images captured from multiple angles to ensure reliable identification, even if certain views of the container are obstructed or poorly lit.

In embodiments, the identification manager 123 may use a train car identification model of models 115 configured to detect and recognize the identification of train cars carrying the containers detected in the sensor data. This train car identification model may be trained to identify various types of train car markings, including painted numbers, RFID tags, and/or other identification methods used by railroad operators. The train car identification model may be configured to handle different styles of markings and account for variations in lighting conditions, viewing angles, potential obstructions, etc.

In a particular embodiment, the identification manager 123 may analyze image data from the one or more cameras 192 to determine the identification of the train car carrying the container with the abnormal condition. This may include analyzing specific areas of the train car where identification markings are typically located, such as the sides or ends of the car. The identification manager 123 may employ image enhancement techniques to improve the visibility of these markings in challenging lighting conditions or when the markings are partially obscured.

In embodiments, the identification manager 123 may use a train identification model of models 115 configured to detect and recognize the identification of the train to which the train car belongs. This train identification model may be trained to identify unique train identifiers, such as locomotive numbers or train symbols, which may be visible in the captured sensor data. In some embodiments, the train identification model may work in conjunction with other data sources, such as train schedules or real-time tracking systems, to corroborate and enhance the accuracy of train identification.

In a particular embodiment, the identification manager 123 may analyze image data from the one or more cameras 192 to determine the identification of the train to which the train car belongs. This may include capturing and processing images of the locomotive or other parts of the train that display identifying information. In some embodiments, the identification manager 123 may be configured to handle scenarios where the train identification is not immediately visible, by inferring the train identity from other available information, such as the sequence of identified train cars.

In some embodiments, the identification manager 123 may utilize contextual information to enhance its identification accuracy. For example, the identification manager 123 may consider the location of the inspection site, the time of day, the expected train schedules, etc. to narrow down the possible identities of trains and containers passing through the system.

The message manager 124 may be configured to compile and structure the abnormal condition detection, the identification data associated with the abnormal condition detection, and/or the sensor data associated with the abnormal condition detection into a detection message 108 that may be sent to the backend system 155. In embodiments, the detection message 108 may represent a detection of an abnormal condition associated with a container (e.g., container 142 in the example illustrated in FIG. 2). In embodiments, the detection message 108 may operate as an indication that there may be a likelihood that the container 142 has been the subject of unauthorized access, tampering, and/or theft.

In some embodiments, the message manager 124 may receive inputs from various components of the on-site system 105, including the abnormal condition manager 122 and the identification manager 123. The message manager 124 may aggregate this information into a structured format suitable for transmission and processing by the backend system 155 to generate the detection message 108. In embodiments, the detection message 108 may include various types of data. For example, the detection message 108 may include raw sensor data captured by the one or more sensors 190, which may include unprocessed images or video footage in which the abnormal condition was detected. In embodiments, the detection message 108 may include processed image data with annotations or visual indicators highlighting the detected abnormal conditions. For example, the message manager 124 may incorporate bounding boxes, arrows, or other graphical elements to pinpoint the location and nature of the detected abnormal condition within the image.

In some embodiments, the message manager 124 may structure the detection message 108 as a JavaScript Object Notation (JSON) message, which may allow for a hierarchical organization of data, making it easy to include multiple types of information within a single message. For example, the JSON structure may include separate fields for container identification, train car identification, train identification, detected abnormal conditions, sensor data, and/or any additional metadata relevant to the abnormal condition detection. In additional or alternative embodiments, the message manager 124 may be configured to structure the detection message 108 using other data structures or formats, depending on specific operation requirements (e.g., of the on-site system 105 and/or the backend system 155). In embodiments, for example, these formats may include eXtensible Markup Language (XML), Protocol Buffers, custom binary formats, etc.

In some embodiments, the message manager 124 may include data compression functionality to reduce the size of the detection message 108. This may be particularly beneficial when including large amounts of sensor data such as high-resolution images or video streams. This compression functionality of the message manager 124 may operate to optimize network bandwidth usage and reduce transmission times between the on-site system 105 and the backend system 155.

In embodiments, the message manager 124 may be configured to generate multiple detection messages 108, such as when multiple abnormal conditions are detected for the same container and/or for different containers within a short period of time and/or in rapid succession. In some embodiments, the message manager 124 may, instead of or in addition to generating multiple detection messages 108, consolidate the multiple detections into a single detection message 108.

In embodiments, once the detection message 108 has been compiled and structured, the message manager 124 may provide to the I/O manager 125. In embodiment, the I/O manager 125 may be configured to transmit (e.g., via network 145) the detection message 108 to the backend system 155. In some embodiments, detection messages 108 generated by the message manager 124 may be stored to database 114 for logging and/or historical analysis.

FIG. 3 is a block diagram illustrating an example implementation of backend system 155 with functionality for processing detecting abnormal conditions associated with a shipping container in accordance with embodiments of the present disclosure. As shown in FIG. 3, the backend system 155 may be implemented in a server (e.g., server 160). In embodiments, functionality of server 160 to facilitate operations of the backend system 155 may be provided by the cooperative operation of the various components of server 160, as will be described in more detail below.

It is noted that although FIG. 3 shows server 160 as a single server, it will be appreciated that server 160 (and the individual functional blocks of server 160) may be implemented as separate devices and/or may be distributed over multiple devices having their own processing resources, whose aggregate functionality may be configured to perform operations in accordance with the present disclosure. Furthermore, those of skill in the art would recognize that although FIG. 3 illustrates components of server 160 as single and separate blocks, each of the various components of server 160 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 160 may actually be part of a different component of server 160, and as such, the description of the particular functionality described for the particular component of server 160 is for illustrative purposes and not limiting in any way.

As shown in FIG. 3, server 160 may include processor 161, memory 162, database 164, shipment data manager 171, report manager 172, notification manager 173, and I/O manager 174. Processor 161 may comprise a processor, a microprocessor, a controller, a microcontroller, a plurality of microprocessors, an ASIC, an ASSP, or any combination thereof, and may be configured to execute instructions to perform operations in accordance with the disclosure herein. In some embodiments, implementations of processor 161 may comprise code segments (e.g., software, firmware, and/or hardware logic) executable in hardware, such as a processor, to perform the tasks and functions described herein. In yet other embodiments, processor 161 may be implemented as a combination of hardware and software. Processor 161 may be communicatively coupled to memory 162.

Memory 162 may comprise one or more semiconductor memory devices, ROM devices, RAM devices, one or more HDDs, flash memory devices, SSDs, EROM, CD-ROM, optical disks, other devices configured to store data in a persistent or non-persistent state, network memory, cloud memory, local memory, or a combination of different memory devices. Memory 162 may comprise a processor readable medium configured to store one or more instruction sets (e.g., software, firmware, etc.) which, when executed by a processor (e.g., one or more processors of processor 161), perform tasks and functions as described herein.

Memory 162 may also be configured to facilitate storage operations. For example, memory 162 may comprise a database 164 for storing various information related to operations of backend system 155. For example, the database 164 may store configuration information related to operations of the backend system 155. In embodiments, the database 114 may store detection data 180. The detection data 180 may include information received from the on-site system 105 through detection messages 108. In some embodiments, the database 164 may organize the detection data 180 into categories such as abnormal conditions 181, which may include data related to detected abnormal conditions such as open doors, tampered seals, or other indicators of potential theft or tampering; train data 182, which may comprise information about trains associated with detected abnormal conditions, such as train identifiers or schedules; car data 183, which may include details about specific train cars carrying containers with detected abnormal conditions; and sensor data 184, which may encompass raw or processed data from various sensors used in the detection process, such as image data from cameras or readings from other types of sensors.

Database 164 is illustrated as integrated into memory 162, but in some embodiments, database 164 may be provided as a separate storage module or may be provided as a cloud-based storage module. Additionally, or alternatively, database 164 may be a single database, or may be a distributed database implemented over a plurality of database modules.

In some embodiments, the backend system 155 may be provided as a cloud-based system. This cloud-based configuration may allow for scalable and flexible processing of detection messages 108 received from multiple on-site systems 105. The cloud-based backend system 155 may leverage distributed computing resources to handle large volumes of data and perform complex analyses in real-time. By utilizing cloud infrastructure, the backend system 155 may enable users to access and manage detection data 180 from various locations. The cloud-based architecture may also facilitate easier integration with other enterprise systems and databases, which may enhance the functionality of the system 100.

Backend system 155 may be configured to receive the detection message 108 from the on-site system 105, including the abnormal condition and identification data, and may operate to handle the alerting and reporting, and remedial actions in response to the abnormal condition detected.

The shipment data manager 171 may be configured to obtain and process information related to various aspects of the shipment associated with the container with the detected abnormal condition. In embodiments, the shipment data may include information that may identify various components, aspects, parties, etc., related to the shipment associated with the container with the detected abnormal condition. For example, in embodiments, the shipment data manager 171 may acquire or obtain data related to the shipment associated with the container with the detected abnormal condition from various databases (e.g., internal and/or external databases) and may include, but is not limited to, train destination, train schedule (e.g., including anticipated stops and locations), waybill number and date, customer information, original seal information (e.g., which may allow the backend system 155 to more accurately determine if tampering has occurred, such as by validating whether the detected abnormal condition is a security concern or potentially a false alarm based on a comparison of the original seal information with the seal information as reported in the detected anomaly), a load status for the container (e.g., which may provide information about whether the container is supposed to be full, partially loaded, or empty), etc. In some embodiments, the shipment data manager 171 may query these databases concurrently with querying for a train symbol. This data acquisition functionality may allow for a more thorough assessment of the shipment context and may help in determining appropriate responses to the detected abnormal condition.

In some embodiments, the data acquisition functionality of the shipment data manager 171 may provide a more informed context to determine an appropriate response to the detected abnormal condition. For example, the shipment related data obtained by the shipment data manager 171 may help operators make decisions as to whether to immediately halt the train for inspection, schedule an inspection at the next planned stop, flag the container for closer examination at its destination, etc. This may help to prioritize responses, especially when multiple abnormal conditions are detected across different shipments.

In embodiments, the shipment data manager 171 may be configured to process information from the train data 182 and/or car data 183 to generate a unique train symbol associated with the train carrying the container with the detected abnormal condition. In some embodiments, the shipment data manager 171 may be configured to map the identification data detected by the on-site system 105 to an actual train symbol used in the operator’s internal systems.

In embodiments, the shipment data manager 171 may ingest various types of data from the train data 182, such as locomotive numbers, train numbers, and/or other identifiers captured by the on-site system 105. In some embodiments, the shipment data manager 171 may also include information from the car data 183, which may include details about specific train cars, their positions within the train consist, their relationship to the container with the detected abnormal condition, etc.

In embodiments, the shipment data manager 171 may use a lookup table or database to correlate the ingested identification data with the corresponding train symbols used in the operator’s internal systems. In embodiments, the shipment data manager 171 may include functionality to validate and verify the generated train symbols. This functionality may include cross-checking the generated symbol against other available data points, such as the location of the detection, the time of the detection, historical patterns of train movements, etc. In some embodiments, the shipment data manager 171 may assign confidence scores to its symbol determinations.

In embodiments, the shipment data manager 171 may be configured to determine the location of the train within the operator’s system. This location information may be derived from various sources, such as the known position of the on-site system 105 where the abnormal condition was detected, GPS data associated with the train or specific cars, or integration with the operator's train tracking systems.

In embodiments, the output of the shipment data manager 171 may be used by other components of the backend system 155, such as the report manager 172 and the notification manager 173, to generate precise and actionable alerts and reports.

The report manager 172 may be configured to generate reports for various stakeholders related to detected abnormal conditions associated with containers based on the detection data 180. In embodiments, the report manager 172 may utilize data from multiple sources within the backend system 155, including the detection data 180, train data 182, car data 183, and sensor data 184, to generate detailed reports related to detected abnormal conditions associated with containers.

In embodiments, the report manager 172 may generate different types of reports configured for specific stakeholder. For example, for operators, the reports generated by the report manager 172 may include detailed information about the nature and location of detected abnormal conditions, along with recommended actions and potential impact on operations. For managers, the report manager 172 may generate higher-level summary reports that provide an overview of abnormal condition detections across multiple trains or routes. These higher-level summary reports may include statistical analyses, key performance indicators, visualizations, etc. to help management make informed decisions about resource allocation and security strategies.

In some embodiments, the report manager 172 may generate customer reports intended for customers and that provide information about the status and security of their containers. These reports may be configured to balance transparency with security considerations, and may operate to notify the customers of detected abnormal conditions including detailed information associated with the abnormal condition detected. These customer reports may serve as notification to the customer of the potential tampering and/or theft associated with their container, which may abrogate the risk that the customer may discover the signs of tampering when their container is delivered to the final destination.

In embodiments, the report manager 172 may include data visualization functionality to enhance the clarity of the generate reports. For example, the generated reports may include charts, graphs, heat maps, and/or other visual representations of data to help stakeholders quickly grasp key information related to abnormal condition detections. In embodiments, the report manager 172 may include functionality to generate real-time or near-real-time reports, and may include functionality for report customization and filtering. For example, the report manager 172 may include functionality to allow users to focus on specific types of abnormal conditions and/or other relevant criteria.

The notification manager 173 may be configured to generate alert signals configured to cause and/or actuate one or more actions in response to the abnormal condition detections. For example, in embodiments, the notification manager 173 may be configured to generate alerts signals configured to notify relevant personnel of detected abnormal conditions associated with containers. In additional or alternative examples, the notification manager 173 may be configured to generate automated alerts based on the information received from other components of the backend system 155, such as the shipment data manager 171, the report manager 172, etc.

In embodiments, the format and/or structure of an alert signal generated by the notification manager 173 may be based on the severity and nature of the detected abnormal condition in response of which the alert signal is generated. In some embodiments, the notification manager 173 may format the alert signal as a text message, email, push notifications to mobile devices of designated personnel, a notification on a dashboard associated with backend 155, etc. In some embodiments, the alert signals may include audible alarms and/or visual indicators, which may include audible alarms and/or visual indicators at specific locations within the railroad environment 140.

In embodiments, the content of the alert signals generated by the notification manager 173 may be based on the recipient and the nature of the abnormal condition. For example, the alert signals generated by the notification manager 173 may include one or more of a description of the detected abnormal condition, an identification of the affected train car, an identification of the specific container on which the abnormal condition was detected, an identification of the train, and the train symbol generated by the shipment data manager 171. In some embodiments, the alert signals generated by the notification manager 173 may include other relevant information associated with the detected abnormal condition that may enable operators and/or customers to respond to the abnormal condition.

In some embodiments, the notification manager 173 may include prioritization functionality configured to determine the urgency of alert signals and the appropriate recipients. For example, certain types of abnormal conditions may trigger immediate notifications to on-site security personnel, while others may be included in daily summary reports to management.

In some embodiments, the notification manager 173 may be configured to interface with automated systems to initiate remedial actions in response to detected abnormal conditions. For example, in some embodiments, the alert signal generated by the notification manager 173 may include an automated signal configured to cause a piece of equipment to be actuated to take a remedial action. For example, the notification manager 173 may send a signal to automated sorting equipment divert a container with a detected abnormal condition to a designated inspection area, such as by actuating a gate or other type of sorting equipment to cause the container to be diverted. In some embodiments, the notification manager 173 may trigger the activation of additional security measures, such as increased surveillance or the deployment of security personnel to a specific location.

In some embodiments, the notification manager 173 may include functionality to determine the most appropriate remedial action based on the nature and severity of the detected abnormal condition. For example, in embodiments where a container door is detected as being open, the notification manager 173 may trigger an automated system to attempt to close the container door and/or resecure the container. In more severe cases, such as signs of forced entry, the notification manager 173 may initiate protocols for potential theft response, which may include notifying law enforcement agencies.

In some embodiments, the notification manager 173 may include confirmation and feedback functionality. For example, recipients of alert signals may be required to acknowledge receipt and indicate the actions taken in response. This response information may be logged by the notification manager 173 and may be used to improve future alert processes and assess the effectiveness of response protocols, as well as for escalation purposes. In some embodiments, the notification manager 173 may include escalation functionality. For example, in some embodiments, if an initial alert signal does not receive a response within a predetermined timeframe, the notification manager 173 may automatically escalate the alert signal to higher-level personnel or initiate more aggressive remedial actions.

In embodiments, the notification manager 173 may use machine learning and/or artificial intelligence models to improve the alert signal generation and routing functionality. For example, by analyzing patterns in alert responses and outcomes, the notification manager 173 may refine its prioritization and escalation procedures over time, which may improve the efficiency and effectiveness of the backend system 155.

The I/O manager 174 may be configured to facilitate communication between the backend system 155 and external components, such as the user terminal 130 and other systems within the railroad environment 140. In some embodiments, the I/O manager 174 may handle the transmission of reports generated by the report manager 172 and alert signals produced by the notification manager 173 to appropriate recipients and/or devices and systems.

In embodiments, the I/O manager 174 may be configured for managing data flow in and out of the backend system 155. This functionality may include receiving detection messages 108 from the on-site system 105, processing incoming data from various sources, ensuring that outgoing information is properly formatted and securely transmitted to its intended destination, etc. In some embodiments, the I/O manager 174 may include security protocols to protect data during transmission. For example, the I/O manager 174 may include encryption functionality, secure socket layer (SSL) connections, virtual private network (VPN) tunnels, etc.

In some embodiments, the I/O manager 174 may be configured to generate and serve a dashboard interface to users via the user terminal 130. This dashboard may be configured to provide a comprehensive overview of abnormal detection information related to system 100. The dashboard functionality may allow operators to access real-time or near-real-time data on detected abnormal conditions, system performance metrics, and/or other relevant information. In embodiments, operators, through the dashboard, may be enabled to access specific details of abnormal condition detections, access historical data, generate custom reports based on their specific needs or areas of interest, etc. In embodiments, the I/O manager 174 may configure the dashboard to include data visualization tools, such as charts, graphs, maps, and/or other visual representations that illustrate trends or patterns in detected abnormal conditions. These visualizations may help operators grasp complex data, identify areas that require immediate attention, etc.

In some embodiments, the dashboard may be configured to provide functionality for users to set and adjust various configuration parameters through the dashboard interface. In some embodiments, this may include settings related to detection sensitivity, reporting frequency, alert thresholds, etc. In embodiments, users may be able to acknowledge alerts, assign tasks to team members, initiate remedial actions, etc. directly through the dashboard interface.

In some embodiments, data and/or results from the container classification manager 121, the abnormal condition manager 122, and/or the identification manager 123 may be corrected by a user via user terminal 130. For example, if based the available data, the user determines the container detection, the abnormal condition detection, and/or the container identification is incorrect in the data collected, the user may correct the incorrect data via user terminal 130.

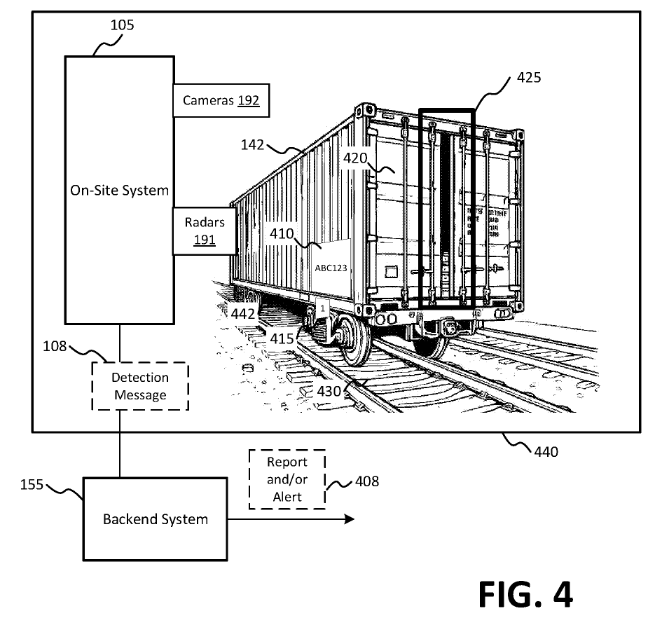

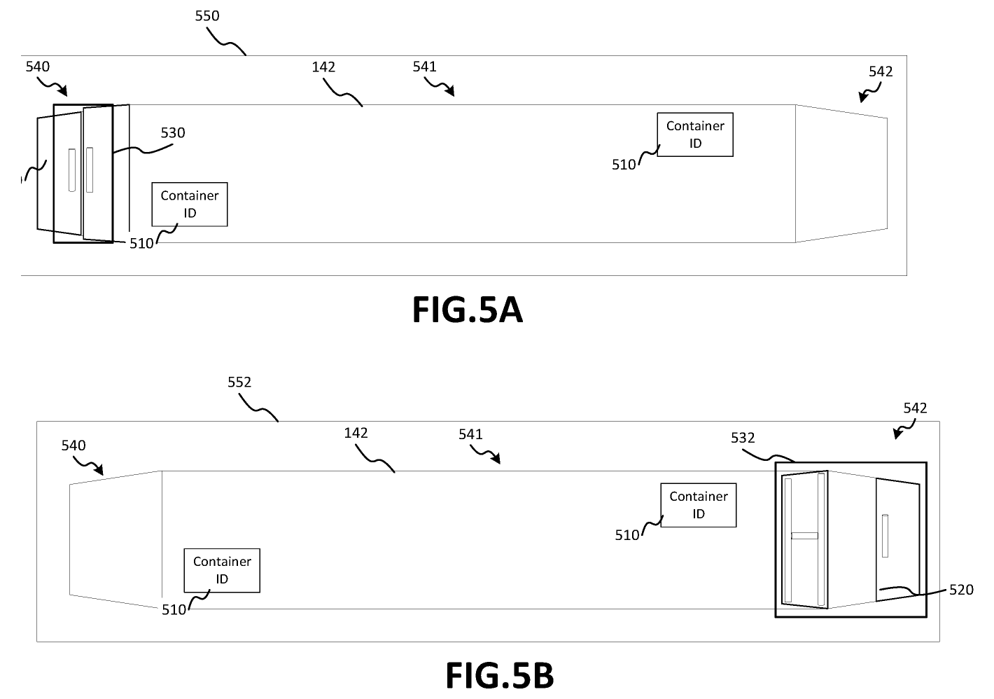

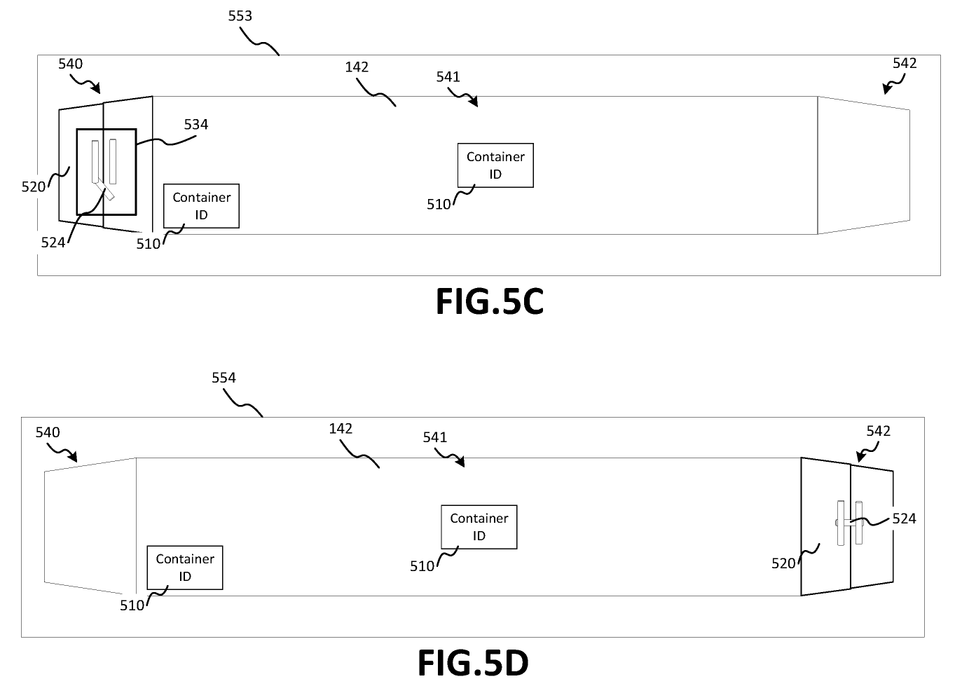

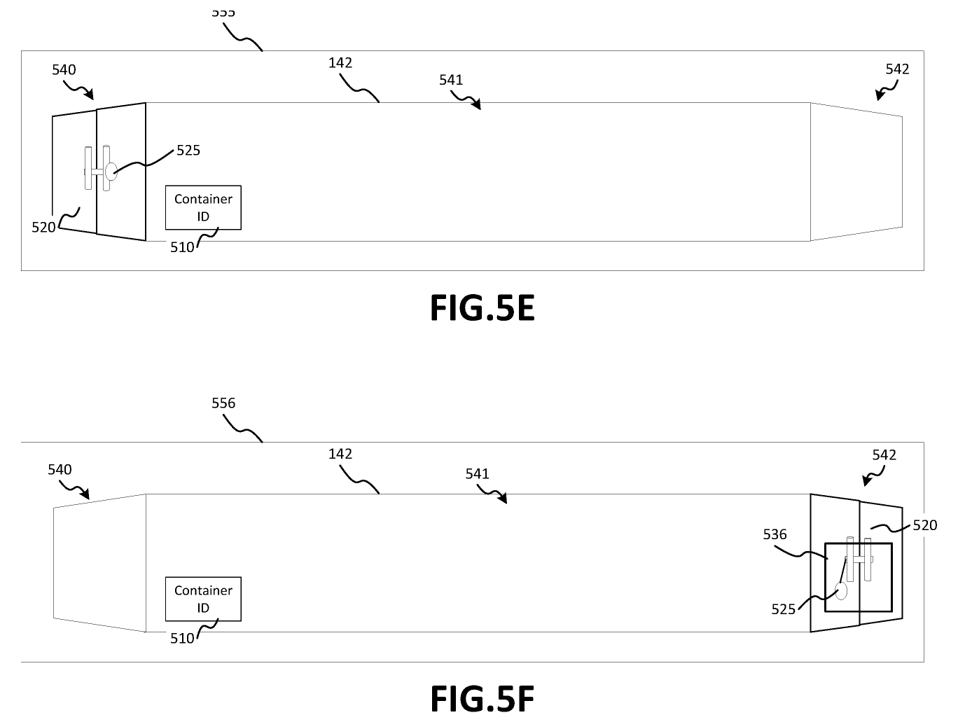

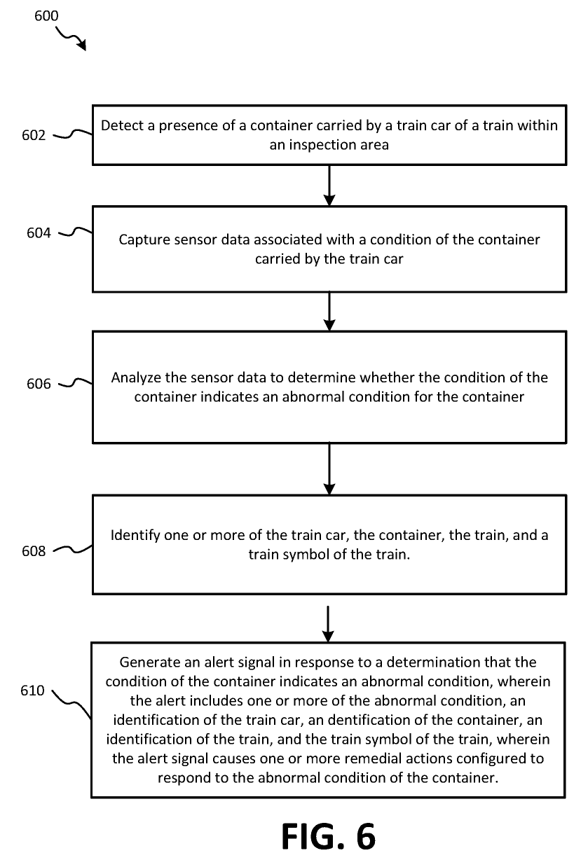

FIG. 6 shows a high-level flow diagram 600 of operation of a system configured for intelligent detection of abnormal conditions associated with a shipping container in accordance with embodiments of the present disclosure. For example, the functions illustrated in the example blocks shown in FIG. 6 may be performed by system 100 of FIG. 1 according to embodiments herein. In embodiments, the operations of the method 600 may be stored as instructions that, when executed by one or more processors, cause the one or more processors to perform the operations of the method 600. The operations illustrated in FIG. 6 will be described with further reference to FIGS. 4 and 5A-5F. FIG. 4 illustrates an example of an abnormal condition detected by a system in accordance with embodiments of the present disclosure. In embodiments, the abnormal condition illustrated in FIG. 4 may be detected using a system (e.g., system 100) configured with functionality for intelligent detection of abnormal conditions associated with a shipping container. FIGS. 5A-5F illustrate various examples of image data including various examples of abnormal conditions that may be detected by a system configured with functionality for intelligent detection of abnormal conditions associated with a shipping container in accordance with embodiments of the present disclosure.

At block 602, the presence of a container carried by a train car of a train is detected within an inspection area. For example, as shown in FIG. 4, the one or more radars 191 (and/or other sensors of the one or more sensors 190 of the on-site system 105) may be used to detect the presence of container 142 carried by train car 442 within the inspection area 440. In embodiments, the functionality of a data acquisition manager (e.g., the data acquisition manager 120 of FIG. 2) may be used to receive and/or monitor the signals from the one or more radars 191 and to determine, based on the received signals, whether a container, a train car, and/or a train is present within the inspection area 440. In embodiments, the inspection area 440 may represent an area for which the on-site system 105 may have visibility (e.g., using the one or more sensors 190) and may include a physical portal and/or a tower disposed along the railroad track 430.

At block 604, sensor data associated with a condition of the container carried by the train car is captured. For example, the detection of the container 142 within the inspection area 440 may trigger sensors of the one or more sensors 190 to begin capturing sensor data. The sensor data may include image data captured by the one or more cameras 192 of different sides of the container 142. In embodiments, the captured sensor data may include image data of different sides of the container 142. This may include one or more ends of the container 142 and/or the middle portion of the container 142. In particular, the image data may include an image of the container door 420 of the container 142. In some embodiments, the image data of container 142 may be include a visualization of the entire container, end-to-end. For example, the data acquisition manager 120 may correlate side and end view data to create an end-to-end representation of the container, which may include a view of the container from one end to the other. FIGS. 5A-5F illustrate various examples of the image data that includes a visualization of the container from the first end 540 all the way to the second end 542, including the middle 541 of the container 142. This end-to end visualization enable the system 100 to detect and classify the container, detect the location of the container door, and detect any abnormal conditions of the container 142.

At block 606, the sensor data is analyzed to determine whether the condition of the container indicates an abnormal condition for the container. For example, in embodiments, functionality of a container classification manager (e.g., the container classification manager 121 of FIG. 2) may be used to detect and classify container 142 in the sensor data, and functionality of an abnormal condition manager (e.g., the abnormal condition manager 122 of FIG. 2) may be used to determine whether the container 142 includes an abnormal condition. In this example, the container 142 includes the abnormal condition 425, which in this case includes an open container door 420.

In embodiments, the container classification manager 121 may apply one or more models (e.g., from the models 115) to the sensor data to detect the container 142 within the sensor data and to classify the container 142 into a type of container. The container classification manager 121 may filter out the sensor data if the type of container 142 is not of a type being inspected (e.g., it is not an intermodal container). However, the container classification manager 121 may not filter out the sensor data if the type of container 142 is of a type being inspected. In this latter case, the sensor data associate with the container 142 may be provided to the abnormal condition manager 122 for abnormal condition detection.

In embodiments, the abnormal condition manager 122 may apply one or more models (e.g., from the models 115) to the sensor data to detect whether the container 142 includes an abnormal condition. In embodiments, this may include applying one or more models to detect the container door 420, and applying one or more models to the sensor data and/or the container door detection to determine whether the container door 420 and/or any component of the container door 420 includes an abnormal condition. The abnormal conditions that may be detected may include open doors, tampered seals (e.g., broken, replaced, missing, misplaced), tampered handles (e.g., hanging handles, handles not properly engaged), broken locks, misaligned container components, unusual wear patterns, signs of forced entry, missing security tags, damaged container walls or doors, unexplained holes or openings, loose or missing bolts/fasteners, signs of repainting or repair work, presence of unauthorized markings or labels, unusual weight discrepancies, etc. In this example, the abnormal condition 425, which includes an open container door 420, may be detected.

FIGS. 5A-5F illustrate various examples of abnormal and normal conditions of the container 142. For example, FIG. 5A illustrates image data 550 captured by one or more cameras 192 of the on-site system 105 including a container 142. In embodiments, the image data 550 may represent a comprehensive view that includes the front, rear, and middle portions of the container 142. For example, the image data 550 may include a first end 540, a middle section 541, and a second end 542 of the container 142. In this example, the abnormal condition manager 122 may detect a container door 520 at the first end 540 using one or more models from models 115 applied to the sensor data. In this example, the abnormal condition manager 122 may not detect a door at the second end 542. The abnormal condition manager 122 may detect an abnormal condition 530 using one or more models of models 115. In this example, the abnormal condition 530 may include an open container door 520 at the first end 540. Additionally, an identification manager, such as identification manager 123 of FIG. 2, may detect a container ID 510 at one or more locations on the middle section 541 of the container 142.

FIG. 5B illustrates image data 552 captured by one or more cameras 192 of the on-site system 105 including a container 142. In embodiments, the image data 552 may include a visualization of the front, rear, and middle portions of the container 142, including the first end 540, the middle section 541, and the second end 542. In this example, the abnormal condition manager 122 may detect the container door 520 at the second end 542 (e.g., using one or more models from models 115 applied to the sensor data). In this example, the abnormal condition manager 122 may not detect a door at the first end 540. The abnormal condition manager 122 may detect an abnormal condition 532 (e.g., using one or more models of models 115). In embodiments, the abnormal condition 532 may include an open container door 520 at the second end 542. Additionally, the identification manager 123 may detect a container ID 510 at one or more locations on the middle section 541 of the container 142.

FIG. 5C illustrates image data 553 captured by one or more cameras 192 of the on-site system 105 including a container 142. In embodiments, the image data 553 may include a visualization of the front, rear, and middle portions of the container 142, including the first end 540, the middle section 541, and the second end 542. In this example, the abnormal condition manager 122 may detect the container door 520 at first end 540 (e.g., using one or more models from models 115 applied to the sensor data). In this example, the abnormal condition manager 122 may not detect a door at the second end 542. The abnormal condition manager 122 may detect an abnormal condition 534 (e.g., using one or more models of models 115). In embodiments, the abnormal condition 534 may include a tampered handle 524 (e.g., the handle may be hanging, broken, or otherwise show signs of having been tampered with) at first end 540. Additionally, the identification manager 123 may detect a container ID 510 at one or more locations on the middle section 541 of the container 142.

FIG. 5D illustrates image data 554 captured by one or more cameras 192 of the on-site system 105 including a container 142. In embodiments, the image data 554 may include a visualization of the front, rear, and middle portions of the container 142, including the first end 540, the middle section 541, and the second end 542. In this example, the abnormal condition manager 122 may detect the container door 520 at second end 542 (e.g., using one or more models from models 115 applied to the sensor data). In this example, the abnormal condition manager 122 may not detect a door at the first end 540. In this example, the abnormal condition manager 122 may not detect an abnormal condition for the container 142. In this case, the system 100 may not generate abnormal condition detection alerts or reports.

FIG. 5E illustrates image data 555 captured by one or more cameras 192 of the on-site system 105 including a container 142. In embodiments, the image data 555 may include a visualization of the front, rear, and middle portions of the container 142, including the first end 540, the middle section 541, and the second end 542. In this example, the abnormal condition manager 122 may detect the container door 520 at first end 540 (e.g., using one or more models from models 115 applied to the sensor data). In this example, the abnormal condition manager 122 may not detect a door at the second end 542. In this example, the abnormal condition manager 122 may not detect an abnormal condition for the container 142. In this case, the system 100 may not generate abnormal condition detection alerts or reports.

FIG. 5F illustrates image data 556 captured by one or more cameras 192 of the on-site system 105 including a container 142. In embodiments, the image data 556 may include a visualization of the front, rear, and middle portions of the container 142, including the first end 540, the middle section 541, and the second end 542. In this example, the abnormal condition manager 122 may detect the container door 520 at second end 542 (e.g., using one or more models from models 115 applied to the sensor data). In this example, the abnormal condition manager 122 may not detect a door at the first end 540. The abnormal condition manager 122 may detect an abnormal condition 536 (e.g., using one or more models of models 115). In this example, the abnormal condition 536 may include a tampered seal 525 (e.g., the seal may be broken, damaged, misplaced, missing, replaced, or otherwise show signs of having been tampered with) at second end 542. Additionally, the identification manager 123 may detect a container ID 510 at one or more locations on the middle section 541 of the container 142.

At block 608, one or more of the train car, the container, the train, and a train symbol of the train is identified. For example, in embodiments, functionality of an identification manager (e.g., the identification manager 123 of FIG. 2) may be used to obtain an identification of one or more of the container 142, the train car 442, and/or the train to which the train car 442 belongs.

The detection of the abnormal condition may trigger the generation of a detection message 108 (e.g., by message manager 124) that may include the detected abnormal condition and identification information related to the detected abnormal condition. For example, the detection message 108 may include an indication of the open container door 420 and the identification data associated with the abnormal detection 425, which may include identification information related to the identify of the container 142 (e.g., ID: ABC123 in this example, as determined by an identification manager such as identification manager 123 of FIG. 2, based on the sensor data), the train car 442 (e.g., ID: 1 in this example, as determined by the identification manager) based on the sensor data, and/or the train to which the train car 442 belongs.

At block 610, an alert signal is generated in response to a determination that the condition of the container indicates an abnormal condition. For example, in embodiments, functionality of a report manager (e.g., the report manager 172 of FIG. 3) and/or a notification manager (e.g., the notification manager 173 of FIG. 3) may be used to generate the report and/or alert 408. In embodiments, the alert signal may include one or more of the abnormal condition, the identification of the train car 442, the dentification of the container 142, the identification of the train to which the train car 442 belongs, the train symbol of the train. In embodiments, the alert signal may cause one or more remedial actions configured to respond to the abnormal condition of the container.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims, if any.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements, if any, unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims, if any. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims, if any. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims, if any, are intended to include within their scope such processes, machines, manufacture, compositions of matter, means, methods, or steps.

What is claimed is:

1. A method for intelligent detection of abnormal conditions associated with a shipping container, the method comprising:
detecting a presence of a container carried by a train car of a train within an inspection area;
capturing sensor data associated with a condition of the container;
analyzing the sensor data to determine whether the condition of the container indicates an abnormal condition for the container;
identifying one or more of the train car, the container, a train to which the train car belongs, and a train symbol associated with the train; and
generating an alert signal in response to a determination that the condition of the container indicates an abnormal condition, wherein the alert signal includes one or more of the abnormal condition, an identification of the train car, an identification of the container, an identification of the train to which the train car belongs, and the train symbol associated with the train, wherein the alert signal causes one or more remedial actions configured to respond to the abnormal condition of the container.

2. The method of claim 1, wherein the one or more remedial actions include sending an automated signal to actuate a physical component to sort the container to a designated inspection area.

3. The method of claim 1, wherein generating the alert signal comprises:
transmitting, to a backend system, a detection message including the one or more of the abnormal condition, the identification of the train car, the identification of the container, the identification of the train to which the train car belongs, and the train symbol associated with the train; and
generating, by the backend system, the alert signal based on the detection message.

4. The method of claim 3, further comprising:
receiving, by the backend system, the detection message; and
obtaining, by the backend system, shipment data associated with the container by querying a database, wherein the shipment data includes at least one of a train destination, a waybill number, and a load status of the container.

5. The method of claim 1, wherein analyzing the sensor data includes:
applying a container classification model to the sensor data to classify a type of the container;
filtering out the sensor data based on the type of the container not being a type designated for inspection; and
applying an abnormal condition detection model to the filtered sensor data to determine whether the abnormal condition is present.

6. The method of claim 1, wherein the abnormal condition includes at least one of an open door, a tampered seal, a tampered handle, a broken lock, a misaligned container component, an unusual wear patterns, a sign of forced entry, a missing security tag, a damaged container wall or door, an unexplained hole or opening, a loose or missing bolt or fastener, a sign of repainting or repair work, a presence of unauthorized markings or labels, and an unusual weight discrepancy.

7. The method of claim 1, wherein analyzing the sensor data to determine whether the condition of the container indicates the abnormal condition includes:
detecting a door of the container within the sensor data using a container door detection model; and
assessing a condition of the door to determine the abnormal condition.

8. The method of claim 1, wherein analyzing the sensor data is performed using one or more machine learning models.

9. The method of claim 1, further comprising:
generating a report for a customer associated with the container, wherein the report includes information about the detected abnormal condition.

10. A system for intelligent detection of abnormal conditions associated with a shipping container, the system comprising:
at least one processor; and
a memory operably coupled to the at least one processor and storing processor-readable code that, when executed by the at least one processor, is configured to perform operations comprising:
detecting, by an on-site system, a presence of a container carried by a train car of a train within an inspection area;
capturing, by the on-site system, sensor data associated with a condition of the container;
analyzing, by the on-site system, the sensor data to determine whether the condition of the container indicates an abnormal condition for the container;
identifying, by the on-site system, one or more of the train car, the container, a train to which the train car belongs, and a train symbol associated with the train; and
generating, by a backend system, an alert signal in response to a determination that the condition of the container indicates an abnormal condition, wherein the alert signal includes one or more of the abnormal condition, an identification of the train car, an identification of the container, an identification of the train to which the train car belongs, and the train symbol associated with the train, wherein the alert signal causes one or more remedial actions configured to respond to the abnormal condition of the container.

11. The system of claim 10, wherein the one or more remedial actions include sending an automated signal to actuate a physical component to sort the container to a designated inspection area.

12. The system of claim 10, wherein generating the alert signal comprises:
transmitting, from the on-site system to the backend system, a detection message including the one or more of the abnormal condition, the identification of the train car, the identification of the container, the identification of the train to which the train car belongs, and the train symbol associated with the train; and
generating, by the backend system, the alert signal based on the detection message.

13. The system of claim 12, further comprising:
receiving, by the backend system, the detection message; and
obtaining, by the backend system, shipment data associated with the container by querying a database, wherein the shipment data includes at least one of a train destination, a waybill number, and a load status of the container.

14. The system of claim 10, wherein analyzing the sensor data includes:
applying a container classification model to the sensor data to classify a type of the container;
filtering out the sensor data based on the type of the container not being a type designated for inspection; and
applying an abnormal condition detection model to the filtered sensor data to determine whether the abnormal condition is present.

15. The system of claim 10, wherein the abnormal condition includes at least one of an open door, a tampered seal, a tampered handle, a broken lock, a misaligned container component, an unusual wear patterns, a sign of forced entry, a missing security tag, a damaged container wall or door, an unexplained hole or opening, a loose or missing bolt or fastener, a sign of repainting or repair work, a presence of unauthorized markings or labels, and an unusual weight discrepancy.

16. The system of claim 10, wherein analyzing the sensor data to determine whether the condition of the container indicates the abnormal condition includes:
detecting a door of the container within the sensor data using a container door detection model; and
assessing a condition of the door to determine the abnormal condition.

17. The system of claim 10, wherein analyzing the sensor data is performed using one or more machine learning models.

18. The system of claim 10, further comprising:
generating, by the backend system, a report for a customer associated with the container, wherein the report includes information about the detected abnormal condition.

19. The system of claim 10, wherein the on-site system includes an edge computing system configured to perform the analyzing of the sensor data locally at a site where the sensor data is captured before transmitting the detection message to the backend system.

20. A computer-based tool for intelligent detection of abnormal conditions associated with a shipping container including non-transitory computer readable media having stored thereon computer code which, when executed by a processor, causes a computing device to perform operations comprising:
detecting a presence of a container carried by a train car of a train within an inspection area;
capturing sensor data associated with a condition of the container;
analyzing the sensor data to determine whether the condition of the container indicates an abnormal condition for the container;
identifying one or more of the train car, the container, a train to which the train car belongs, and a train symbol associated with the train; and
generating an alert signal in response to a determination that the condition of the container indicates an abnormal condition, wherein the alert signal includes one or more of the abnormal condition, an identification of the train car, an identification of the container, an identification of the train to which the train car belongs, and the train symbol associated with the train, wherein the alert signal causes one or more remedial actions configured to respond to the abnormal condition of the container.
